(19) United States
(12) Patent Application Publication
(10) Pub. No.: US 2017/0208550 A1
(43) Pub. Date: Jul. 20, 2017

(54) METHOD AND APPARATUS FOR ENERGY-OPTIMIZED DATA TRANSMISSION BY MEANS OF OPC UA PROTOCOL

(71) Applicant: SIEMENS AKTIENGESELLSCHAFT, 80333 München (DE)

(72) Inventors: Karl-Heinz Deiretsbacher, Effeltrich (DE); CHRISTIAN HOCK, Fürth (DE); GERALD KAEFER, München (DE); FRANK VOLKMANN, Nürnberg (DE)

(73) Assignee: SIEMENS AKTIENGESELLSCHAFT, 80333 München (DE)

(21) Appl. No.: 15/325,013

(22) PCT Filed: Jul. 10, 2014
(86) PCT No.: PCT/EP2014/064810

§ 371 Date: Jan. 9, 2017

(51) Int. Cl. H04W 52/02; H04L 12/26; H04L 29/08

(52) U.S. Cl. CPC H04W 52/0241; H04L 67/145; H04L 43/10; H04L 67/42

(57) ABSTRACT

An OPC UA client that consolidates transmission and reception times so as to extend the antenna amplifier pause times is disclosed. Thus, without requiring a change to the OPC UA protocol, data is sent exclusively at defined focusing times. No sending is meant to be necessary between these times. A set of requests is sent to the server at a particular time. The client then enters reception mode. The server handles the received requests periodically over time. When almost all requests have been handled, a new set of requests is made to the server again. Between these focusing times, the transmitter of the client/mobile device can be switched off completely and hence save power. The method disclosed is totally compatible at all levels of communication, both TCP stack, WLAN for instance.

OPC UA (OPC Unified Architecture) is a standard industrial protocol of the OPC Foundation for manufacturer-independent communication for the exchange of machine data, particularly in process automation.

OPC UA is a relatively new standard in which the original focus was not on controlling an industrial plant but instead on the standardized exchange of information, particularly between devices of different manufacturers.

In the meantime, OPC UA is also integrated directly into automation-technology devices so that there is a necessity for consistent writing of data.

In automation-technology systems, there is the necessity of exchanging process information (like process values, measurement values, parameters, control commands) between different devices. In this context, it is of importance that the information is transmitted consistently and in a fault-proof manner between the subscribers. This is of particular importance in the case of data-changing calls (i.e. the writing of variables).

The OPC UA protocol is also able to communicate via Internet connections. In the Internet, the agreement predominates that a client/server communication must always be initiated by the client, that is to say that only the client may render enquiries to the server and then the server may respond to this enquiry. However, this collides with the requirement of automation installations that the communication must be initiated at any time by both communication partners.

This problem is solved by OPC UA at present in that it sends in advance already at least one (or more) enquiries from the client to the server. If the server wishes to send data to the client, it can do this in conformity with the protocol as response to one of these enquiries. These enquiries are called “publish-request” and the associated response “publish-response”. As a rule, up to three enquiries are presented. If there is no requirement to send data to the client from the server for a period of time, it sends a “blank” response, also called “keep-alive”.

If the client receives a response “publish-response” to one of his enquiries “publish-request”, it sends a new enquiry to the server.

This “keep-alive” mechanism is necessary since the data traffic in the internet is monitored by firewalls/proxies and similar network elements. These network elements close a connection if no data traffic has flown through it for some time.

Furthermore, this mechanism is also used for informing the communication partner about the correct operation of the connection.

Mobile devices communicate wirelessly, by radio such as wireless LAN, Bluetooth, 3G, LTE. Since they are usually supplied with power by means of a battery or an accumulator and the energy requirement of the applications running on the device has a direct effect on the running time of the device, they have to operate as energy-efficiently as possible. The greatest energy consumption in mobile devices arises during the sending of messages. The antenna is, therefore, activated as little as possible for transmitting. Receiving, in contrast, is uncritical from the point of view of energy consumption.

If then an OPC-UA communication is operated in a mobile device (e.g. as mobile access to a part of the installation for the purpose of maintenance, monitoring, parameterization, etc.) transmission occurs frequently due to the OPC-UA-related communication behaviour based on enquiry-response (request/response). Since the device rarely manages to switch off the transmitter, the accumulator/battery of the device is discharged very rapidly.

In the definition of the OPC-UA standard, the circumstance of mobile communication was not taken into consideration. Mobile terminals (such as, e.g., MOBIC, MOBile Industrial Communicator, of the Siemens company, a mobile, industrially capable Internet pad for local or global access to the Intranet and Internet with plug-in radio cards and wireless LAN), which are already used today in installations, communicate via different protocols.

At present, there is still no established solution for this problem. It is only expected increasingly in future the spread of OPC-UA and the increasing use of mobile terminals in the case of maintenance.

It is the object of the invention to specify a method and a device which eliminates the problems described above.

The object described is solved by a method and a device as claimed in one of the independent patent claims.

The method according to the invention is used for communication between at least one client and at least one server of a client/server system, using the communication protocol OPC-UA, via a communication network which is distinguished by permitting enquiries only from at least one client and subsequent responses only from at least one server, and which comprises a keep-alive mechanism, a data link existing between the server and the client being terminated if no data packets are transmitted over a keep-alive period, particularly the Internet. The client sends out a number of enquiries following one another directly in time and the server receives the number of enquiries and responds to these offset in time. In this context, there is a period between a first response and a subsequent second response which is shorter than the keep-alive period.

The first device according to the invention, the server, is suitable for carrying out the method according to the invention via a communication network which is distinguished by permitting enquiries only from at least one client and subsequent responses only from the device, and which comprises a keep-alive mechanism, a data link existing between the server and the client being terminated if no data packets are transmitted over a keep-alive period, particularly the Internet. The device receives from a client a number of enquiries which have been sent out following one another directly in time, and responds to the number of enquiries offset in time, the period lying between a first response and a subsequent second response being shorter than the keep-alive period.

The second device according to the invention, the client, is suitable for performing the method according to the invention via a communication network which is distinguished by the fact of permitting enquiries only from the device and subsequent responses only from a server and which comprises a keep-alive mechanism, a data link existing between the server and the device being terminated if no data packets are transmitted over a keep-alive period of time, particularly the Internet. The device sends out a number of enquiries following one another directly in time and the at least one server responds to the number of enquiries offset in time, the period lying between a first response and a subsequent second response being shorter than the keep-alive period of time.

In order to lengthen the running time of the mobile device, an OPC-UA client is enabled, according to the invention, to bundle the transmitting and receiving times in order to thus lengthen the antenna amplifier interval times.

Without this requiring a change of the OPC-UA protocol, an OPC-UA client should transmit exclusively at defined focusing times. Between these times, transmitting should not be necessary. For this purpose, the OPC-UA client is modified so that it sends a bundle of enquiries to the server at a particular time, for example 50 enquiries. After that, the client changes to receive mode.

The server processes the received enquiries periodically over the time. Once almost all enquiries have been processed (after 48 enquiries in the example), a new bundle of enquiries is again sent to the server.

Between these focus times, the transmitter of the client/mobile device can be switched off completely and thus save power.

The method presented here is fully compatible with all levels of communication (TCP stack, WLAN).

In the text which follows, the invention is represented and explained further by figures. In this context,

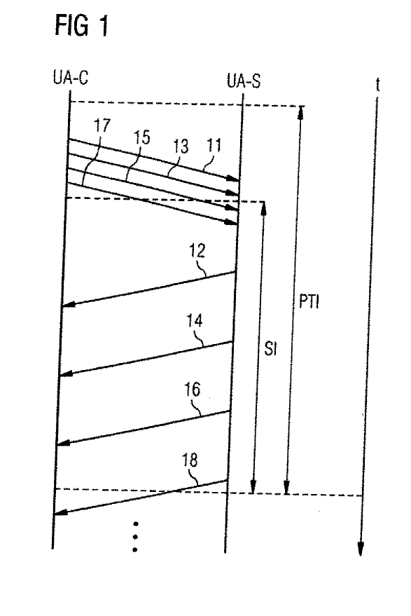

FIG. 1 shows an exemplary communication between client and server according to the claimed method,

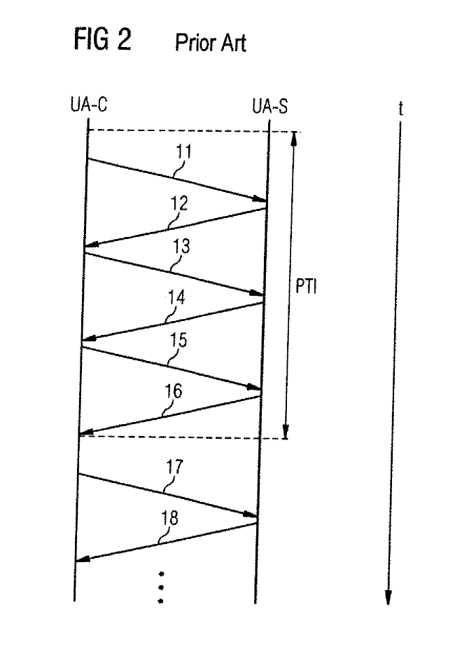

FIG. 2 shows an exemplary communication between client and server according to the prior art,

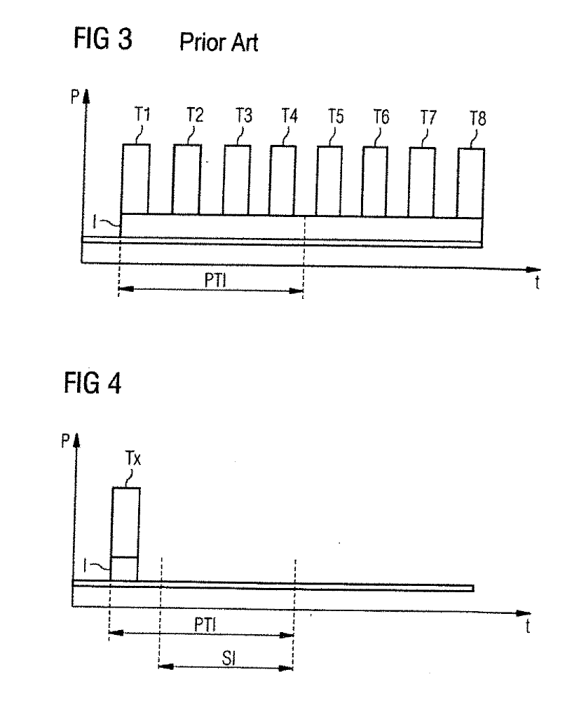

FIG. 3 shows a representation of the energy requirement in the client when proceeding according to the prior art, and

FIG. 4 shows a representation of the energy requirement when proceeding in accordance with the claimed method.

FIG. 2 initially describes the normal procedure of a client/server communication. The client UA-C sends an enquiry 11 to which the server UA-S sends a response 12. Following this, the client UA-C sends a second enquiry 13 to which the server UA-S sends a response 14, and so forth. This happens, in particular, so that a communication has taken place between client UA-C and server UA-S in the keep-alive time interval PTI and the communication channel is not closed due to a timeout problem.

FIG. 3 shows the energy requirement P of the terminal UA-C with the procedure described according to FIG. 2. It can be seen clearly here that each transmitting process, 11, 13, 15, 17 has a power requirement T1, T2, T3, T4 . . . It is thus clear that the power reserve existing only to a restricted amount in a terminal provided with power store is soon consumed.

In comparison, sending out the messages in accordance with the method claimed occurs at a short interval, only indicated for four messages by way of example in the figure here, which is not intended to represent a restriction of the claimed concept but is only used for the sake of clarity of the representation. In the subsequent period SI, the terminal UA-C can be changed into a current-saving mode or even switched off and does not then consume any further power as can be seen well in FIG. 4 where the single power consumption Tx comprises sending all messages of a transmission block.

It is followed by a calculation example which calculates the current saving on an exemplary arrangement.

In the case of a keep-alive rate (Proxy Timeout Interval, PTI) of 10 seconds (corresponding to half the period of an empirically determined timeout in the case of standard firewalls and proxies) and an assumed number of 50 enquiries in a bundle of enquiries, the client could thus be switched off in idling for approx. 490 seconds.

With a uniform activity and an update rate of 1000 ms, the client could still be switched off for 49 seconds.

In the case of an assumed delay time of the internal processing and the transmitting antenna of 500 ms, the following behavior is then obtained:

In the first case, according to the prior art, the client sends 50 enquiries distributed over 50 seconds, that is to say approximately one enquiry per second.

The response time of the server is within the range of 500 ms, the antenna can thus be switched off for only 50% of the time, the internal processing unit (coding, transmitting, and respectively receiving, decoding messages) is permanently active).

In the second case, the client operates in a 10-second pattern according to the method according to the invention. 50 enquiries are set at once, they are processed within approx. 1 second. After that, the antenna or the processing unit, respectively, goes to sleep. The internal processing unit and antenna are then activated again only at the next point of synchronization.

The savings potential obtained from this is:

Potential sleep time in power saving mode:

10 s−1 s−0.5 s=8.5 s per 10 second interval=85%

Power saving potential over a 50 second interval:

The power in the first case corresponds to=50 s idling+50 s processing+25 s transmitting.

The power in the second case corresponds to=50 s idling+15 s processing+15 s transmitting.

1.-7. (canceled)

8. A method of communication in a communication network, between at least one client and at least one server in a client/server system using the OPC-UA communication protocol in which only one server responds to an enquiry from a client, and a keep-alive mechanism terminates a data link between the server and the client if no data packets are transmitted between the server and the client during a keep-alive period, said method comprising:
the client sending out a first group of multiple enquiries that follow one another directly in time to the server; and
the server responding to the respective group of multiple enquiries at a time that is offset in time from the time of the respective group of multiple enquires, wherein the period between a first response and a subsequent second response is shorter than the keep-alive period.

9. The method of claim 8, wherein the server apparatus communicates with the client using the Internet.

10. The method of claim 8, wherein the client is on a mobile terminal having a stored-power power supply.

11. The method of claim 8, wherein the client causes the mobile terminal to change into a power-saving operating mode for a period up to the end of the keep-alive period, after sending out the multiple enquiries.

12. The method of claim 8, wherein the multiple enquiries includes at least 50 enquiries.

13. The method of claim 8, wherein a second group of multiple enquiries is sent by the client if the number of enquiries from the first group of multiple enquiries that have not been processed by the server falls below a predetermined value.

14. The method of claim 12, wherein a second group of multiple enquiries is sent by the client if the number of enquiries from the first group of multiple enquiries processed by the server is at least 48 enquiries.

15. Server apparatus for communication in a communication network, between at least one client and at least one server in a client/server system using the OPC-UA communication protocol in which only one server responds to an enquiry from a client, and a keep-alive mechanism terminates a data link between the server and the client if no data packets are transmitted between the server and the client during a keep-alive period, said server apparatus comprising:
the client sending out a first group of multiple enquiries that follow one another directly in time to the server; and
a server responding to the respective group of multiple enquiries at a time that is offset in time from the time of the respective group of multiple enquires, wherein the period between a first response and a subsequent second response is shorter than the keep-alive period.

16. The server apparatus of claim 15, wherein the server apparatus communicates with the client using the Internet.

17. The server apparatus of claim 15 wherein the client causes the mobile terminal to change into a power-saving operating mode for a period up to the end of the keep-alive period, after sending out the multiple enquiries.

18. The server apparatus of claim 15, wherein the first group of multiple enquiries includes at least 50 enquiries.

19. The server apparatus of claim 15, wherein a second group of multiple enquiries is received by the server from the client after the number of enquiries from the first group of multiple enquiries that have not been processed by the server falls below a predetermined value.

20. The server apparatus of claim 18, wherein a second group of multiple enquiries is sent by the client if the number of enquiries from the first group of multiple enquiries processed by the server is at least 48 enquiries.

21. Client apparatus for communication in a communication network, between at least one client and at least one server in a client/server system using the OPC-UA communication protocol in which only one server responds to an enquiry from a client, and a keep-alive mechanism terminates a data link between the server and the client if no data packets are transmitted between the server and the client during a keep-alive period, said client comprising:
a first client routine adapted to send out a first group of multiple enquiries that follow one another directly in time to the server; and
a second client routine adapted to send out a second group of multiple enquiries that follow one another directly in time to the server after the server responds to the respective group of multiple enquiries at a time that is offset in time from the time of the respective group of multiple enquires, wherein the period between a first response and a subsequent second response is shorter than the keep-alive period.

22. The client apparatus of claim 21, wherein the client apparatus is on a mobile terminal having a stored-power power supply.

23. The client apparatus of claim 21, wherein the client causes the mobile terminal to change into a power-saving operating mode for a period up to the end of the keep-alive period, after sending out the first group of multiple enquiries.

24. The client apparatus of claim 21, wherein the first group of multiple enquiries includes at least 50 enquiries.

25. The client apparatus of claim 21, wherein a second group of multiple enquiries is sent if the number of enquiries from the first group of multiple enquiries falls below a predetermined value.

26. The client apparatus of claim 24, wherein a second group of multiple enquiries is sent by the client if the number of enquiries from the first group of multiple enquiries processed by the server is at least 48 enquiries.
